(19) United States
(12) Patent Application Publication
(10) Pub. No.: US 2008/0203232 A9
(43) Pub. Date: Aug. 28, 2008

(54) System and method for reducing the loads acting on the fuselage structure in means of transport

(76) Inventors: Michael Enzinger, Neu Wulmstorf (DE); Michael Kordt, Hamburg (DE)

Correspondence Address: OSTROLENK FABER GERB & SOFFEN, 1180 AVENUE OF THE AMERICAS, NEW YORK, NY, 100368403, US

(21) Appl. No.: 11/154,916

(22) Filed: Jun. 16, 2005

Related U.S. Application Data
(60) Provisional application No. 60/606,665, filed on Sep. 2, 2004.

(30) Foreign Application Priority Data
Jun. 16, 2004 (DE) 102004029196.9

(51) Int. Cl. G05D 1/00

(52) U.S. Cl. 244/195

(57) ABSTRACT

The invention relates to a system for reducing the loads acting on the fuselage structure in means of transport, in particular in aircraft, comprising at least one sensor element 6, at least one actuator, an active material integrated in the fuselage structure or a supporting active force or position set system, and at least one control unit 11.

According to the invention, the amplitude characteristic and/or a phase characteristic of fuselage structure design loads, accelerations and/or deformations are/is modifiable such that a reduction in the design load or acceleration acting on a fuselage structure 5 of a means of transport occurs, as a result of which a significant reduction in weight or improvement in comfort of a means of transport is possible in a particular frequency interval.

Furthermore, the invention relates to a method for reducing the loads acting on the fuselage structure in means of transport, in particular in aircraft, comprising at least one sensor element 6, at least one actuator, an active material integrated in the fuselage structure or a supporting active force or position set system, and at least one control unit 11.

According to the method of the invention, an amplitude characteristic and/or phase characteristic of fuselage structure design loads, accelerations and deformations are/is modified such that a reduction in the design load or acceleration acting on a fuselage structure 5 of a means of transport occurs, as a result of which a significant reduction in weight or improvement in comfort of a means of transport in a particular frequency range is possible.

This application claims the benefit of the filing date of U.S. Provisional Patent Application No. 60/606 665 filed Sep. 2, 2004, the disclosure of which is hereby incorporated herein by reference.

### FIELD OF THE INVENTION

The invention relates to a system and to a method for reducing the loads acting on the fuselage structure in means of transport.

### TECHNOLOGICAL BACKGROUND

Fuselage structure loads and thus the structural design and structural weight and the comfort of large flexible aircraft as well as of aircraft with long front and back fuselage result from the aircraft's dynamic response to gusts and manoeuvres, and the forces resulting there from, respectively.

From the state of the art, aircraft mode and aircraft oscillation type suppression systems, respectively, are known for attenuating selected elastic fuselage bending oscillation types and fuselage bending modes caused by gusts. They are based on control systems using control-, guiding- and/or regulating surfaces, respectively.

They serve merely for attenuating one or several selected fuselage bending modes caused by gusts. Furthermore, devices for wing load reduction are known from the state of the art.

### SUMMARY OF THE INVENTION

There may be a need for a system and a method which make it possible to reduce the loads acting on the fuselage structure of a means of transport.

A significant reduction in the loads acting on the fuselage structure of a means of transport in a particular frequency interval may be possible in that an amplitude characteristics and/or a phase characteristics of structural loads acting on the fuselage can be modified so that a reduction in the load acting on a fuselage structure of a means of transport results. This may allow to meet strength specifications which might be impossible to be met without applying the method. Furthermore, increased comfort in means of transport can be achieved by a system according to an exemplary embodiment of the invention.

According to an exemplary embodiment of the invention, a significant reduction in the loads acting on the fuselage structure of a means of transport in a particular frequency interval may be possible in that an amplitude characteristics and/or a phase characteristics of structural loads acting on the fuselage can be modified so that a reduction in the load acting on a fuselage structure of a means of transport results. This may allow to meet strength specifications which would be impossible to be met without applying the method. Furthermore, increased comfort in means of transport can be achieved by a method according to an exemplary embodiment of the invention.

By means of the system according to an embodiment of the invention and/or the method according to an embodiment of the invention, dynamic fuselage structure design loads, accelerations and/or deformations (hereinafter abbreviated to “fuselage structure loads”), which are induced into the fuselage structure for example by gusts, turbulence or flight manoeuvres, may be reduced with the use of sensor elements for detecting the fuselage movements, at least one control unit for modification of the signals provided by the sensor elements, at least one actuator, an active material or a supporting active force or position set system.

In contrast to an embodiment of the invention, it is believed that known devices or methods do not serve for reducing fuselage structural loads (that is structural loads acting on the fuselage structure).

In order to reduce such fuselage structure loads according to an exemplary embodiment of the invention, it is necessary to simultaneously modify rigid body modes, for example the dutch roll mode and elastic fuselage modes or types of fuselage oscillation including externally enforced oscillation (hereinafter in brief referred to as “fuselage mode”).

Furthermore, a simple attenuation of elastic fuselage modes represents only a very specific modification of the amplitude characteristics and phase characteristics of a mode. An efficient reduction in structural loads according to an exemplary embodiment of the invention therefore necessitates further-reaching modifications of the amplitude position and phase position of the fuselage structure loads.

Consequently, for reducing the loads acting on the fuselage structure according to an exemplary embodiment of the invention, it should not simply be modified the amplitude characteristics and phase characteristics in the region of the elastic modes and of the rigid body modes. Instead, it may be necessary according to an exemplary embodiment of the invention to also modify the frequency range between rigid body modes and elastic modes, and between adjacent elastic modes in such a way that the loads acting on the fuselage structure are reduced as far as possible. This means that an optimal reduction in the loads acting on the fuselage structure may require general modification of the frequency range of the rigid body modes and of the essential elastic modes of the fuselage. In many aircraft, this relevant frequency range may be between 0 and 10 Hz, in some cases in several frequency intervals between 0 and 100 Hz.

According to an exemplary embodiment of the invention, the loads acting on the fuselage structure may be reduced by means of actuators which act upon the control-, guiding- and/or regulating surfaces of the means of transport, in particular of an aircraft. The control-, guiding- and/or regulating surfaces are in particular ailerons and rudders if the system according to an embodiment of the invention or the method according to an embodiment of the invention is used in an aircraft. In an alternative embodiment, at least one actuator (for instance piezoelectric actuators) directly acts on the fuselage structure of the means of transport so as to reduce the loads acting on the fuselage structure. The term fuselage structure may include interior structures, for instance the floor and its lateral and vertical integration or simple interior cross beams. The term actuator includes particularly active controllable and modifiable materials which may be integrated directly in the structure and may include active force and position set systems which are simultaneously mounted in the structure also contributing or promoting the structure. A reduction in the loads acting on the fuselage structure is achieved by modifying the forces and movements impinging on the fuselage structure which are caused by the correspondingly controlled or regulated control-, guiding- (or guide-) and/or regulating surfaces, and/or the actuators acting directly on the fuselage structure, and/or the active materials, and/or the supporting active force and position set systems. The control-, guiding- and/or regulating surfaces influenced by the actuators, as well as any actuators, active materials and/or supporting active force and position set systems which act directly on the fuselage structure can be combined in any desired way both in relation to the way they interact between or among each other, and in relation to their number.

Controlling or regulating the actuators may take place depending on measuring signals acquired by means of sensor elements, which measuring signals after a conversion to a regulated quantity within a control unit may be modified by filter elements and the like to form a set value, wherein the set value modified in this way may be conveyed to the actuators via an amplification factor unit and as a result of this is fed back to the fuselage structure. The set signal/s present at the actuators may represent a regulated quantity. The actuators can act on the fuselage structure directly and/or indirectly via control-, guiding- and/or regulating surfaces so as to reduce the loads acting on the fuselage structure of the means of transport.

Control or regulation by the system according to an embodiment of the invention or the method according to an embodiment of the invention may be effective in parts of or in the entire frequency range of the rigid body modes and/or of the elastic modes of the fuselage structure; it may cover for example a frequency range of between 0 Hz and 10 Hz, or between 5 Hz and 50 Hz.

The term “rigid body mode” may particularly be denoted as “rigid body eigen form”. The term “elastic mode” may particularly be denoted as “elastic eigen form”.

As an addition or as an alternative to the control unit, a regulating unit may be employed according to an exemplary embodiment of the invention.

According to an exemplary embodiment of the invention, it may be advantageous that the loads acting on the fuselage structure may be reduced, which loads can for example be caused by gusts and/or flight manoeuvres, by a drastic modification of the movements in the fuselage structure and of the mechanical forces acting on said fuselage structure in a particular frequency interval.

The effectiveness of the system according to an embodiment of the invention and the number of the available design parameters (for example the sensor elements to be selected, the control-, guiding- and/or regulating surfaces to be determined, the actuators, the selection and the design of a suitable control unit) are varied so that the critical frequency range can be precisely determined according to the loads acting on the fuselage structure, which loads are to be reduced. According to an exemplary embodiment of the invention, this does not bring about any impairment in the aircraft design or in the integrity of said aircraft design.

According to an exemplary embodiment of the invention, a system and a method for fuselage structure design load, acceleration and/or deformation reduction in means of transport, particularly in aircraft, is provided, comprising at least one sensor element, at least one actuator, an active material integrated in the fuselage structure or a supporting active force and/or position set system, and at least one control unit.

According to an exemplary embodiment of the invention, a weight reduction and an improvement in comfort may be obtained.

An exemplary embodiment of the invention relates to a system for reducing the loads acting on the fuselage structure in means of transport, in particular in aircraft, comprising at least one sensor element, at least one actuator, an active material integrated in the fuselage structure or a supporting active force or position set system, and at least one control unit.

According to an exemplary embodiment the invention, the amplitude characteristic and/or a phase characteristic of fuselage structure design loads, accelerations and/or deformations are/is modifiable such that a reduction in the design load or acceleration acting on a fuselage structure of a means of transport occurs, as a result of which a significant reduction in weight or improvement in comfort of a means of transport is possible in a particular frequency interval.

Furthermore, the invention relates to a method for reducing the loads acting on the fuselage structure in means of transport, in particular in aircraft, comprising at least one sensor element, at least one actuator, an active material integrated in the fuselage structure or a supporting active force or position set system, and at least one control unit.

According to the method of the invention, an amplitude characteristic and/or phase characteristic of fuselage structure design loads, accelerations and deformations are/is modified such that a reduction in the design load or acceleration acting on a fuselage structure of a means of transport occurs, as a result of which a significant reduction in weight or improvement in comfort of a means of transport in a particular frequency range is possible.

Further exemplary embodiments of the invention are stated in further claims.

### DETAILED DESCRIPTION OF EXEMPLARY EMBODIMENTS

The following is shown in the drawing:

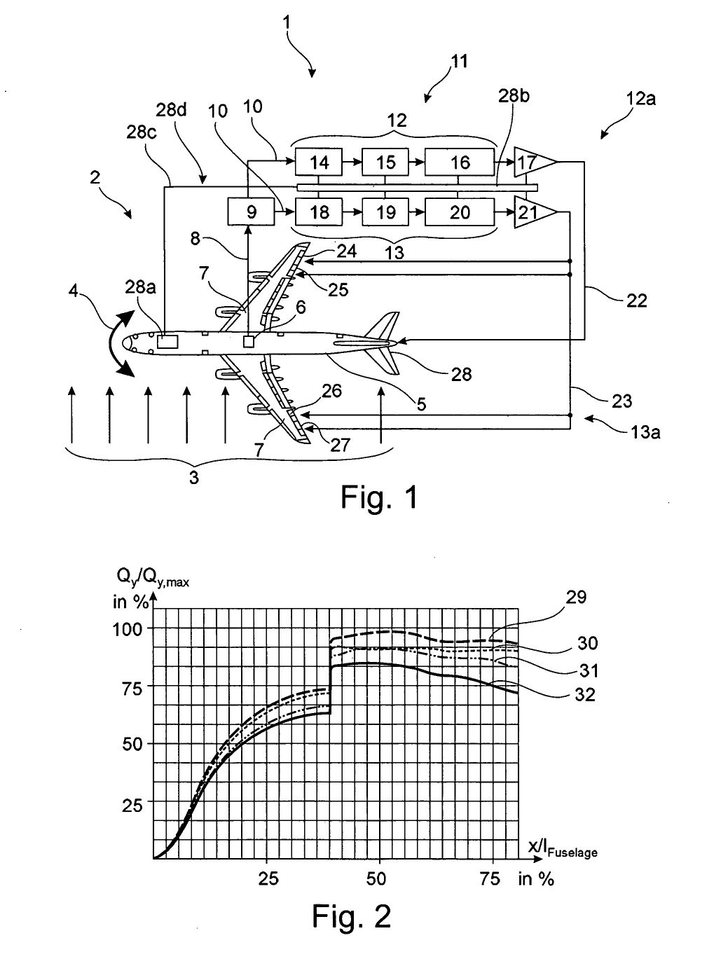

FIG. 1 an exemplary representation of a system for reducing the loads acting on the fuselage structure of an aircraft in the case of lateral loads acting on the fuselage structure;

FIG. 2 Transverse forces Q_{Y} in a fuselage structure of an aircraft with and without the use of the system in three different versions for reducing the loads acting on the fuselage structure;

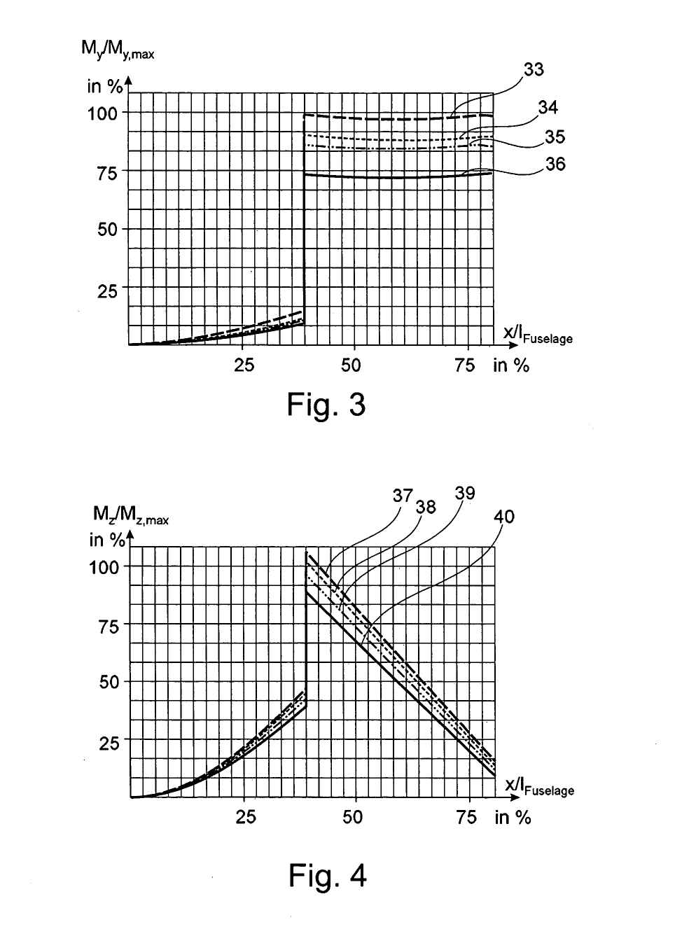

FIG. 3 Bending moment M_{X} in a fuselage structure of an aircraft with and without the use of the system for reducing the loads acting on the fuselage structure; and

FIG. 4 Torsional moment M_{Z} in a fuselage structure of an aircraft with and without the use of the system for reducing the loads acting on the fuselage structure.

FIG. 1 shows a schematic embodiment of the system 1 according to the invention, for reducing the load acting on the fuselage.

An aircraft 2 essentially encounters gusts 3 transversely to a longitudinal direction of the aircraft 2. This results in fuselage structure loads (indicated by a double arrow 4) acting on the fuselage structure 5 of the aircraft 2. The fuselage structure loads are thus essentially caused by the gusts 3. However, such fuselage structure loads can also be induced in the fuselage structure 5 by respective flight manoeuvres of the aircraft 2.

FIG. 1 predominantly illustrates the reduction in lateral fuselage structure loads by means of the system 1 according to the invention, which loads are caused in the fuselage structure 5 by gusts 3. Beyond this, the system 1 according to the invention is equally suited for reducing vertical fuselage structure loads (not shown) and/or for reducing flight-manoeuvre-induced fuselage structure loads (also not shown).

In the embodiment shown, a sensor element 6 is positioned in the area where the wings 7 are attached to the fuselage structure 5. Preferably, the sensor element 6 is positioned in a location where it can detect as well as possible the loads acting on the fuselage structure, either directly or at least by way of the movements or forces caused by said loads. It is particularly advantageous if the sensor element 6 is arranged in a region of the fuselage structure 5 in which the highest loads acting on the fuselage structure occur.

The sensor element 6 can for example be a strain gauge or extensometer, an optical sensor, a Bragg sensor, a piezoelectric sensor, an acceleration sensor, a speed sensor or the like. Furthermore, the use of several sensor elements 6 using identical and/or different technologies in various locations of the fuselage structure 5 of the aircraft 2 is possible.

A measuring signal 8 supplied by the sensor element 6 is first conveyed to a signal processing unit 9, which can for example comprise an anti-aliasing filter, a signal amplifier for changing the amplitude, etc. The sensor element 6 converts any movement in the fuselage structure 5 and/or converts the forces acting on the fuselage structure 5 into the measuring signal 8 which thus contains all essential information about the loads acting on the fuselage structure.

From the signal processing unit 9, the measuring signal 8 reaches the control unit 11 as a control variable 10. At the control unit 11, a corresponding modification takes place by way of filter means and the like for reducing the loads acting on the fuselage structure. For this purpose, in the embodiment shown in FIG. 1, the control unit 10 comprises two regulating lines 12, 13, arranged in parallel. The regulating line 12 comprises a low-pass filter 14, a high-pass filter 15, a phase correction unit 16 as well as an amplification factor unit 17 connected in series. Correspondingly, the regulating line 13 comprises a low-pass filter 18, a high-pass filter 19, a phase correction unit 20 as well as an amplification factor unit 21 connected in series.

The low-pass filters 14, 18 are used to remove higher-frequency components from the control variable 10. The low-pass filters thus let those signals pass whose frequencies correspond to the frequencies of at least one rigid body eigen value and/or of an elastic eigen value. Correspondingly, the high-pass filters 15, 19 are used to remove low-frequency components from the control variable 10. The amplification factor units 17, 21 are used to amplify and to form two set values 22, 23 which by way of actuators (not shown in detail in FIG. 1) act upon the ailerons 24, 25, 26, 27 as well as on the rudder 28 of the aircraft 2. By means of the phase correction units 16, 20, a phase correction of the control variable 10 becomes possible, i.e. a time shift becomes possible in the control variable 10 to compensate further system-imminent delays.

In an alternative embodiment (not shown in FIG. 1) of the system according to the invention it is possible that, additionally or exclusively, actuators are provided which act directly on the fuselage structure 5 of the aircraft 2. These actuators can be piezoelectric actuators, active materials integrated in the fuselage structure, or supporting active force and position set systems, for example they can be hydraulic cylinders whose bearings and piston rods are friction-locked to the fuselage structure.

The control unit 11 comprises an amplification factor “a” which is used for setting the amplitude of the loads acting on the fuselage structure or of the control variable 10, which represents said loads acting on the fuselage structure. Setting the amplification factor “a” can for example take place in the signal processing unit 9 by means of the signal amplifier (not shown in detail) or by means of some other functional unit.

The low-pass filters 14, 18 are parameterised low-pass filters of the first order with f_{low-pass}(s)=1/(s+b) or a higher-order low-pass filter. In this arrangement, the cut-off frequency up to which the low-pass filter allows signals to pass is determined by the parameter “b”. The high-pass filters 15, 19 as well as the phase correction units 16, 20 are not obligatory for proper functioning of the device according to the invention, however, they can further enhance its effectiveness.

The control unit 11 thus acts evenly in the frequency range from 0 Hz to the cut-off frequency determined by the parameter “b”. Normally—due to set rate limitations of the actuators, of the ailerons and the rudder 24, 25, 26, 27, 28, as well as due to system-imminent delays—the technically relevant frequency range is approximately 0 Hz to 10 Hz. By selecting the parameter “b”, the frequency range of the loads acting on the fuselage structure, which frequency range is to be modified, is determined, whereas the parameter “a” only modifies the amplitude characteristics.

The control unit 11 can thus also be integrated into known flight-mechanics regulators or controllers if the flight-mechanics controller also has a low-pass, and if identical sensor elements 6 are used for the flight-mechanics regulator and for the system for reducing the loads acting on the fuselage structure. In this case the cut-off frequency of a low-pass contained in the flight-mechanics regulator would have to be selected so as to be the same as the cut-off frequency of the low-pass filter units 14, 18. In this case the measuring signals of yaw rate sensors, speed sensors, acceleration sensors or the like, which sensors are for example already present in the aircraft as part of a flight-mechanics regulator, can in this case act as sensor elements 6 or measuring signals 8. In such an arrangement, it would essentially only be the rigid body modes—such as the tumbling oscillation and, depending on the regulator, the low-frequency elastic modes relevant from the point of view of flight mechanics, as well as the frequency range between these modes—that would be influenced.

As shown in FIG. 1, the control unit 11 further comprises the phase correction units 16, 20. The frequency behaviour of the phase correction units 16, 20 is defined according to the relation f_{Phase}(s)=−c*s+1/(c*s+1) with the parameter c to be selected freely. In contrast to parameter a, parameter c does not influence the amplitude, but only influences the phase of the loads acting on the fuselage structure or of the control quantities 10 representing said loads.

If the dynamic behaviour of the aircraft 2 in regard to stability, aeroelasticity, comfort, flight mechanics and flight characteristics turns out to be insufficient if only the control unit 11 configured with the parameters a, b is used, the above results in further options of reducing the loads acting on the fuselage structure 5 as a result of the further adjustment option using the additional parameter c.

The high-pass filters 15, 19, which are also shown in FIG. 1, make it possible to use further-reaching filter structures which allow targeted amplitude modification in a particular subinterval of the frequency range from 0 Hz to 10 Hz under consideration. In each case, the cut-off frequencies of the high-pass filters 15, 19 are to be determined by way of a further parameter d. Determining said cut-off frequencies takes place analogously to the procedure for determining the parameter b, as explained in the context of the description of parameterisation the low-pass filters 14, 18.

Due to the shown combination of low-pass filters, high-pass filters, as well as of phase correction units and amplification factor units 14 to 21, efficient reduction in the loads acting on the fuselage structure is possible. If several frequency ranges of loads acting on the fuselage structure are to be modified using the system according to the invention, several such filter combinations have to be connected in parallel, as is the case in the embodiment shown in FIG. 1. A control or regulating branch 12a comprises the sensor element 6, the signal processing unit 9, low-pass filter 14, high-pass filter 15, phase correction unit 16, amplification unit 17 as well as the rudder 28. A control or regulating branch 13a comprises the sensor element 6, the signal processing unit 9, low-pass filter 18, high-pass filter 19, phase correction unit 20, amplification factor unit 21, as well as the ailerons 24, 25, 26, 27. When such control or regulating branches 12a, 13a are connected in parallel, each control or regulating branch can comprise a different sensor element 6, a different actuator and/or different control-, guiding- and/or regulating surfaces.

Since the loads acting on the fuselage structure greatly change as the position of the centre of gravity or the quantity of fuel in the trimming tank of the aircraft 2 changes, and because the position of the centre of gravity due to fuel consumption usually changes only very slowly, the design parameters a, b, c, d of each control or regulating branch 12a, 13a can be adjusted in real time to the current position of the centre of gravity or the quantity of fuel in the trimming tank or the precise weight distribution in the fuselage of the aircraft 2. This requires a computer unit 28a which transmits corresponding signal information 28d—including information on the position of the centre of gravity, the quantity of fuel in the trimming tank, or the weight distribution in the fuselage—to an adjustment unit 28b by way of a line 28c. The adjustment unit 28b then adjusts the parameters a, b, c, d according to this signal information 28d.

In a further embodiment (not shown) of the system according to the invention, additional sensor elements 6 and further guiding surfaces, control surfaces or regulating surfaces and/or further actuators which act directly on the fuselage structure 5 can be provided. In this way, the system can use further feedback with additional high-pass filters, low-pass filters, phase correction units as well as amplification factor units.

In order to determine the parameters a, b, c, d, in the development phase the system requires explicit load criteria of the aircraft 2, which criteria specify that at a particular position in the fuselage structure the loads are reduced as far as possible, or are reduced to below or precisely to a particular threshold value or limiting value. The respective parameters are then to be selected such that the fuselage structure load criteria are met and the loads acting on other components, and the dynamic characteristics of the aircraft (stability, aeroelasticity, comfort, flight mechanics and flight characteristics) are maintained or change only within acceptable values.

FIG. 2 shows transverse forces Q_{y} in a fuselage structure of an aircraft with and without the use of the system 1 according to the invention for reducing the loads acting on the fuselage structure.

At a position x/l_{fuselage}—wherein in each case position x relates to the entire length of the fuselage l_{fuselage}—the vertical axis shows the transverse forces Q_{y}/Q_{y, max} acting on the fuselage structure 5, in each case relating to a maximum transverse force Q_{y, max}. The transverse forces Q_{y}/Q_{y, max} result from a load of the aircraft 2 as a result of lateral gusts 3 acting on the fuselage structure 5 (compare FIG. 1).

The curve shape 29 corresponds to the transverse forces experienced without the system 1 according to the invention for reducing the loads acting on the fuselage structure. In comparison, the curve shapes 30, 31 and 32 show the significant reduction of the transverse forces Q_{y}/Q_{y, max} achieved by means of the system 1 according to the invention along the entire length of the fuselage l_{fuselage}. The differences between the curve shapes 30, 31 and 32 result from a different configuration of the control unit 11 within the system 1. Corresponding modification of the parameters a, b, c, d within the control unit 11—as explained above in the context of the description of FIG. 1—in particular results in a multitude of variation options and optimisation options.

The point of discontinuity in all curve shapes 29, 30, 31, 32 at approximately 37.5% of the fuselage length roughly corresponds to the local area in which the wings 7 are connected to the fuselage structure 5 of the aircraft 2.

The diagram shown in FIG. 3 essentially corresponds to the graphical representation of FIG. 2, except that, in a way that is different from the diagram of FIG. 2, the vertical axis shows the bending moments Mₓ,M_{x, max} of the fuselage structure 5 of the aircraft 2, which bending moments occur at a position x/l_{fuselage}—wherein in each case x relates to the entire length of the fuselage l_{fuselage}—in each case in relation to a maximum bending moment M_{x, max}. The bending moments Mₓ/M_{x, max} shown, in turn result from the loads acting on the aircraft 2 due to gusts 3 acting laterally on the fuselage structure 5 (compare FIG. 1).

Again in a portion at approximately 37.5% of the fuselage length, i.e. essentially in the region where the wings 7 are attached, there is a point of discontinuity in the curve shape of the bending moments Mₓ/M_{x, max}. The curve shape 33 refers to the aircraft 2 without the system 1 according to the invention for reducing the loads acting on the fuselage structure, whereas curve shapes 34, 35 and 36 refer to the bending moment characteristics Mₓ/M_{x, max} which results from the use of the system 1 according to the invention. Here again, the use of the system results in a significant reduction in the bending moments Mₓ/M_{x, max} at the respective positions x/l_{fuselage} of the fuselage structure 5. The differences among the curve shapes 34, 35, 36 are also due to a different configuration of the control unit 11 in the system 1. As far as further details are concerned, reference is thus made to the above explanations in conjunction with the description of FIG. 2.

The diagram shown in FIG. 4 essentially corresponds to the graphic representation in FIG. 3 wherein the vertical axis shows the torsional moments M_{z}/M_{z, max} which occur in the fuselage structure 5—wherein in each case x refers to the overall fuselage length l_{fuselage}—in each case in relation to a maximum bending moment M_{z, max}. The torsional moments M_{z}/M_{z, max} shown also result from the loads acting on the aircraft 2 as a result of gusts 3 acting laterally on the fuselage structure 5 (compare FIG. 1).

The curve shape 37 corresponds to the characteristics of the torsional moments M_{z}/M_{z, max} without the use of the system according to the invention, whereas the curve shapes 38, 39, 40 show the characteristics of the torsional moments M_{z}/M_{z, max}, which characteristics results from the use of the system 1 according to the invention. As shown in FIG. 4, the torsional moments M_{z}/M_{z, max} can also be significantly reduced using the system 1 according to the invention. As far as further details are concerned, reference is made to the description in the context of FIG. 2.

The characteristics in the diagrams of FIGS. 2 to 4 relate to lateral loads in the fuselage structure 5. Comparable curve shapes result in relation to exposure of the fuselage structure 5 to vertical or combined lateral and vertical loads acting on said fuselage structure, and/or as a result of flight-manoeuvre-induced loads acting on the fuselage structure. Here again, a reduction in the load acting on the fuselage occurs as a result of the application of the system according to the invention, with correspondingly adapted sensor elements 6, actuators, control-, guiding- and/or regulating surfaces.

In summary, the diagrams of FIGS. 2 to 4 show that all mechanical loads acting on the fuselage structure 5 of the aircraft 2 can be significantly reduced by the system 1 according to the invention.

When carrying out or performing the method according to the invention by means of the system 1 according to the invention as shown in FIG. 1, the sensor element 6 first detects the loads acting on the fuselage structure in the fuselage structure 5 of the aircraft 2, which loads are indicated by the double arrow 4. The loads acting on the fuselage structure are caused by the gusts 3 which essentially act laterally on the fuselage structure. FIG. 1 is limited to indicating lateral loads acting on the fuselage structure. However, the method according to the invention can also reduce vertical or combined vertical and lateral loads acting on the fuselage structure and/or reduce vertical, or combined vertical and lateral loads acting on the fuselage structure 5 for example induced by flight manoeuvres.

The measuring signal 8 provided by the sensor element or sensor elements 6, of which there is/are one or several, is subsequently conveyed to a signal processing unit 9. Within the signal processing unit 9, the measuring signal 8 is processed, for example by filtering and/or amplification. From the signal processing unit 9, the measuring signal which has been modified to form a controlled quantity 10 is conveyed to the control unit 11. The design of the control unit 11 corresponds to the design already explained in the context of the description of FIG. 1 so that in relation to further details concerning the control unit 11 reference is made to said description.

Within the control unit 11, the controlled quantity 10 is modified to form the set values 22, 23, and is fed back to the ailerons 24, 25, 26 and 27, as well as to the rudder 28, of the aircraft 2 by means of lines and actuators (not shown in detail in the drawing). Due to the feedback of the set values 22, 23 to the control-, guiding- and/or regulating surfaces in the form of ailerons 24, 25, 26, 27, as well as of the rudder 28, of the aircraft 2, a closed control (or regulating) loop results.

By means of corresponding parameterisation of the control unit 11—wherein in relation to further details concerning the determination of the parameters in the control unit 11 reference is made to the description in the context of FIG. 1 above—the loads acting on the fuselage structure of the aircraft 2 in the frequency range of at least one rigid body mode of the fuselage structure 5 and/or the loads acting on the fuselage structure in the frequency range of at least one elastic mode of the fuselage structure 5 of the aircraft 2 are changed to such an extent that a significant reduction in the loads acting on the fuselage structure within the fuselage structure 5 of the aircraft 2 results.

The invention is not limited in any way to means of transport, in particular to aircraft. The invention can advantageously be applied in all large-volume and thus oscillateable spatial structures—for example ships, tall buildings, long bridges as well as large terrestrial vehicles etc.—for reducing loads acting on said structures.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### LIST OF REFERENCE NUMERALS

1 System
2 Aircraft
3 Gusts
4 Double arrow
5 Fuselage structure
6 Sensor element
7 Wing
8 Measuring signal
9 Signal processing unit
10 Controlled quantity
11 Control unit
12 Control line
12a Control branch
13 Control line
13a Control branch
14 Low-pass filter
15 High-pass filter
16 Phase correction unit
17 Amplification factor unit
18 Low-pass filter
19 High-pass filter
20 Phase correction unit
21 Amplification factor unit
22 Set value
23 Set value
24 Aileron
25 Aileron
26 Aileron
27 Aileron
28 Rudder
28a Computer unit
28b Adjustment unit
28c Line
28d Signal information
29 Curve shape
30 Curve shape
31 Curve shape
32 Curve shape
33 Curve shape
34 Curve shape
35 Curve shape
36 Curve shape
37 Curve shape
38 Curve shape
39 Curve shape
40 Curve shape

1. A system for reducing internal loads acting in a fuselage structure of a means of transport, in particular of aircraft, the internal loads acting in the fuselage structure of the means of transport resulting from external loads acting on the fuselage structure, the system comprising
at least one sensor element;
at least one actuator; and
at least one control unit;
wherein amplitude characteristics and/or phase characteristics of the external loads acting on the fuselage structure can be modified such that the internal loads acting in the fuselage structure of the means of transport are reduced with the operation of the at least one sensor element, the at least one control unit, and the at least one actuator when compared to the internal loads acting in the fuselage structure of the means of transport without the operation of the at least one sensor element, the at least one control unit, and the at least one actuator.

2. The system of claim 1,
wherein by means of the at least one sensor element the external loads acting on the fuselage structure are convertible to form at least one measuring signal for forming at least one control variable, wherein by means of the control unit the control variable can be converted to form at least one set value such that a feedback of the set value to the at least one actuator results in modification of the amplitude characteristics and/or phase characteristics of the external loads acting on the fuselage structure, as a result of which the internal load reduction in the fuselage structure of the means of transport occurs.

3. The system of claim 1,
wherein by means of the at least one control unit the internal loads acting in the fuselage structure in the frequency range of at least one rigid body mode of the fuselage structure and/or the internal loads acting in the fuselage structure in the frequency range of at least one elastic mode of the fuselage structure of the means of transport can be reduced.

4. The system of claim 1,
wherein the at least one control unit comprises at least one low-pass filter as well as an amplification factor unit arranged downstream of the at least one low-pass filter.

5. The system of claim 4,
wherein at least one phase correction unit is assigned to at least one of the at least one low-pass filter.

6. The system of claim 4, wherein at least one high-pass filter is assigned to at least one of the at least one low-pass filter.

7. The system of claim 1,
wherein the at least one actuator is adapted to act on control-, guiding-, and/or regulating surfaces of the means of transport, in particular on ailerons and rudder.

8. The system of claim 1,
wherein the at least one actuator is adapted to act directly onto the fuselage structure.

9. The system of claim 1,
wherein a computer unit supplies signal information concerning a position of a centre of gravity, a quantity of fuel in a trimming tank, and/or a fuselage weight distribution to an adjustment unit for adapting one or more control lines.

10. A method for reducing internal loads acting in a fuselage structure of a means of transport, in particular of aircraft, by a system comprising at least one sensor element, at least one actuator and at least one control unit, the internal loads acting in the fuselage structure of the means of transport resulting from external loads acting on the fuselage structure,
wherein the method comprises the step of
modifying amplitude characteristics and/or phase characteristics of the external loads acting on the fuselage structure such that the internal loads acting in the fuselage structure of the means of transport are reduced with the operation of the at least one sensor element, the at least one control unit, and the at least one actuator when compared to the internal loads acting in the fuselage structure of the means of transport without the operation of the at least one sensor element, the at least one control unit, and the at least one actuator.

11. The method of claim 10,
comprising the step of converting, by means of the at least one sensor element the external loads acting on the fuselage structure to form at least one measuring signal for forming at least one control variable, and, by means of the at least one control unit, converting the control variable to form at least one set value, and feeding the set value back to the at least one actuator, which results in a modification of the amplitude characteristics and/or phase characteristics of the external loads acting on the fuselage structure, which results in the internal load reduction in the fuselage structure of the means of transport.

12. The method of claim 10,
comprising the step of reducing, by means of the at least one control unit, the internal loads acting in the fuselage structure in the frequency range of at least one rigid body mode and/or the internal loads acting in the fuselage structure in the frequency range of at least one elastic mode of the fuselage structure of the means of transport.

13. The method of claim 11,
comprising the step of modifying, by means of at least one low-pass filter contained in the at least one control unit, oscillation fractions from the control variable, which fractions represent at least one of the rigid body modes of the fuselage structure, and/or represent at least one of the elastic modes of the fuselage structure.

14. The method of claim 13,
comprising the step of carrying out, by means of at least one phase correction unit assigned to the at least one low-pass filter, a phase correction of the control variable.

15. The method of claim 14,
comprising the step of modifying, by means of at least one high-pass filter assigned to the at least one low-pass filter and/or the at least one phase correction unit, lower-frequency oscillation fractions of the control variable.

16. The method of claim 11,
comprising the step of conveying, by means of at least one amplification factor unit, the set value to the at least one actuator, and the at least one actuator acts on control-, guiding- and/or regulating surfaces of the means of transport, in particular on ailerons and rudder.

17. The method of claim 10,
wherein the at least one actuator directly acts on the fuselage structure of the means of transport.

18. The method of claim 10,
comprising the step of generating signal information concerning a position of a centre of gravity, a quantity of fuel in a trimming tank, and/or a fuselage weight distribution by means of a computer unit for adaptation of at least one control line.
